(19) United States
(12) Patent Application Publication
(10) Pub. No.: US 2018/0096601 A1
(43) Pub. Date: Apr. 5, 2018

(54) COLLISION ALERT SYSTEM

(71) Applicant: Toyota Motor Engineering & Manufacturing North America, Inc., Erlanger, KY (US)

(72) Inventors: Justin J. Chow, Los Angeles, CA (US); Lincoln Morfin, Long Beach, CA (US)

(21) Appl. No.: 15/285,427

(22) Filed: Oct. 4, 2016

(51) Int. Cl. G08G 1/16

(52) U.S. Cl. CPC G08G 1/162

(57) ABSTRACT

A vehicle encroachment warning system. The system includes a proximity sensor of a first vehicle configured to detect proximity data of a second vehicle. The system includes an electronic control unit (ECU) of the first vehicle. The first vehicle ECU is configured to determine a proximity of the second vehicle to a lane marker, a proximity of the second vehicle to the first vehicle, or a rate of change of proximity of the second vehicle to the first vehicle based on the proximity data to detect a possible collision. The system also includes a first vehicle transceiver configured to communicate warning data to the second vehicle when the possible collision is detected and a second vehicle transceiver configured to receive the warning data. The system also includes a second vehicle ECU configured to output a warning indication to a driver of the second vehicle based on the warning data.

### BACKGROUND

### 1. Field

The present disclosure relates to a system and a method for alerting a driver of a vehicle of a potential collision, and more particularly to a system and a method for detecting a potential collision between two vehicles and outputting an alert based on the detection of the potential collision.

### 2. Description of the Related Art

A vehicle may be traveling on a road alongside one or more other vehicles. A driver of the vehicle may notice another vehicle in an adjacent lane driving erratically or improperly. The driver of the other vehicle may be distracted, impaired, or simply not a skilled driver. If the other vehicle gets too close and a possible collision may occur, the driver may honk to alert the driver of the other vehicle. Based on hearing the honking, the driver of the other vehicle may be alerted to his/her erratic or improper driving, and may pay more attention.

However, honking may not be sufficient to alert the driver of the other vehicle of the potential danger of his/her erratic or improper driving. Further, honking is imprecise, as it may not necessarily be directed toward a particular vehicle. As a result, other non-offending drivers may become distracted or the offending driver may disregard the honking, assuming it was directed to another driver. Thus, there is a need for a system and a method for detecting a potential collision between two vehicles and outputting a specifically targeted alert based on the detection of the potential collision.

### SUMMARY

What is described is a vehicle encroachment warning system. The system includes a proximity sensor of a first vehicle, the proximity sensor is configured to detect proximity data associated with a proximity of a second vehicle to the first vehicle. The system also includes an electronic control unit (ECU) of the first vehicle. The ECU of the first vehicle is configured to determine a proximity of the second vehicle to a lane marker, a proximity of the second vehicle to the first vehicle, or a rate of change of proximity of the second vehicle to the first vehicle based on the proximity data to detect a possible collision between the first vehicle and the second vehicle. The ECU of the first vehicle is also configured to generate warning data for the second vehicle when the possible collision is detected. The system also includes a first vehicle transceiver configured to communicate the warning data to the second vehicle. The system also includes a second vehicle transceiver configured to receive the warning data. The system also includes an ECU of the second vehicle configured to output a warning indication to a driver of the second vehicle based on the warning data.

Also described is a vehicle. The vehicle includes a proximity sensor configured to detect proximity data associated with an encroaching vehicle. The vehicle also includes an electronic control unit (ECU). The ECU is configured to determine at least one of a distance of the encroaching vehicle to a lane marker, a distance of the encroaching vehicle to the vehicle, or a rate of change of proximity of the encroaching vehicle to the vehicle based on the proximity data to detect a possible collision with the encroaching vehicle. The ECU is also configured to generate a warning indication when the possible collision is detected. The vehicle also includes an output unit configured to output the warning indication to the encroaching vehicle to alert a driver of the encroaching vehicle of the possible collision.

Also described is a vehicle encroachment warning method. The method includes detecting, by a proximity sensor of a first vehicle, proximity data associated with a proximity of a second vehicle to the first vehicle. The method also includes determining, by an electronic control unit (ECU) of the first vehicle, a proximity of the second vehicle to a lane marker, a proximity of the second vehicle to the first vehicle, or a rate of change of proximity of the second vehicle to the first vehicle based on the proximity data to detect a possible collision between the first vehicle and the second vehicle. The method also includes generating, by the ECU of the first vehicle, warning data for the second vehicle when the possible collision is detected. The method also includes communicating, to the second vehicle by a first vehicle transceiver, the warning data. The method also includes receiving, by a second vehicle transceiver, the warning data. The method also includes outputting, by an ECU of the second vehicle at least one of a visual indication displayed by a display unit of the second vehicle, an audio indication output by a speaker of the second vehicle, or a tactile indication output by a vibration unit of the second vehicle, to a driver of the second vehicle based on the warning data.

### BRIEF DESCRIPTION OF THE DRAWINGS

Other systems, methods, features, and advantages of the invention will be or will become apparent to one of ordinary skill in the art upon examination of the following figures and detailed description. It is intended that all such additional systems, methods, features, and advantages be included within this description, be within the scope of the invention, and be protected by the accompanying claims. Component parts shown in the drawings are not necessarily to scale, and may be exaggerated to better illustrate the important features of the invention. In the drawings, like reference numerals designate like parts throughout the different views, wherein:

FIG. 1A illustrates a first vehicle traveling alongside a second vehicle, according to an embodiment of the invention;

FIG. 1B illustrates the second vehicle encroaching on the lane of the first vehicle, according to an embodiment of the invention;

FIG. 1C illustrates the first vehicle communicating a warning indication to the encroaching vehicle, according to an embodiment of the invention;

FIG. 1D illustrates a side view of the first vehicle and illustrates warning indications output by the first vehicle, according to an embodiment of the invention;

FIG. 1E illustrates a warning indication within the cabin of the encroaching vehicle, according to an embodiment of the invention;

FIG. 1F illustrates a warning indication output by the second vehicle, according to an embodiment of the invention;

FIG. 2A illustrates the first vehicle determining a maneuver to avoid the second vehicle when a side vehicle is traveling alongside the first vehicle, according to an embodiment of the invention;

FIG. 2B illustrates the first vehicle determining a maneuver to avoid the second vehicle when a front vehicle is traveling in front of the first vehicle, according to an embodiment of the invention;

FIG. 2C illustrates the first vehicle determining a maneuver to avoid the second vehicle when a rear vehicle is traveling behind the first vehicle, according to an embodiment of the invention;

FIG. 3 illustrates a block diagram of the first vehicle, according to an embodiment of the invention;

FIG. 4 illustrates a block diagram of the second vehicle, according to an embodiment of the invention; and

FIG. 5 illustrates an example of a flowchart describing the collision alert system, according to an embodiment of the invention.

### DETAILED DESCRIPTION

Disclosed herein are systems and methods for detecting a potential collision between two vehicles and outputting an alert based on the detection of the potential collision. The systems and methods described herein provide several benefits and advantages, such as alerting a driver of a vehicle which may not have assistive warning technology. For example, a first vehicle and a second vehicle may be traveling alongside each other. The second vehicle may not have any assistive warning technology to indicate to the driver of the second vehicle that the second vehicle is either traveling outside of its lane or is dangerously close to another vehicle. When the second vehicle does not have any assistive warning technology, the driver of the first vehicle may be responsible with alerting the second driver so that a possible collision is avoided. The first driver may honk or flash the headlights of the first vehicle, but it may not be effective to capture the attention of the driver of the second vehicle. In addition, having to honk or otherwise call the attention of another driver may distract the driver of the first vehicle.

The collision alert system described herein automatically outputs a warning indication by outputting a visual indication or an audio indication when the first vehicle detects a possible collision involving the second vehicle. In addition, the collision alert system described herein may output warning data to the second vehicle, so that the second vehicle may alert the driver using a visual indication, an audio indication, or a tactile indication within the cabin of the second vehicle. In this way, even if the second vehicle is equipped with assistive warning technology, the collision alert system described herein may complement the assistive warning technology by providing an additional warning to the driver of the second vehicle. The driver of the second vehicle receives a specifically targeted alert from the first vehicle.

An exemplary system includes a proximity sensor of a first vehicle, the proximity sensor is configured to detect proximity data associated with a proximity of a second vehicle to the first vehicle. The system also includes an electronic control unit (ECU) of the first vehicle. The ECU of the first vehicle is configured to determine a proximity of the second vehicle to a lane marker, a proximity of the second vehicle to the first vehicle, or a rate of change of proximity of the second vehicle to the first vehicle based on the proximity data to detect a possible collision between the first vehicle and the second vehicle. The ECU of the first vehicle is also configured to generate warning data for the second vehicle when the possible collision is detected. The system also includes a first vehicle transceiver configured to communicate the warning data to the second vehicle. The system also includes a second vehicle transceiver configured to receive the warning data. The system also includes an ECU of the second vehicle configured to output a warning indication to a driver of the second vehicle based on the warning data.

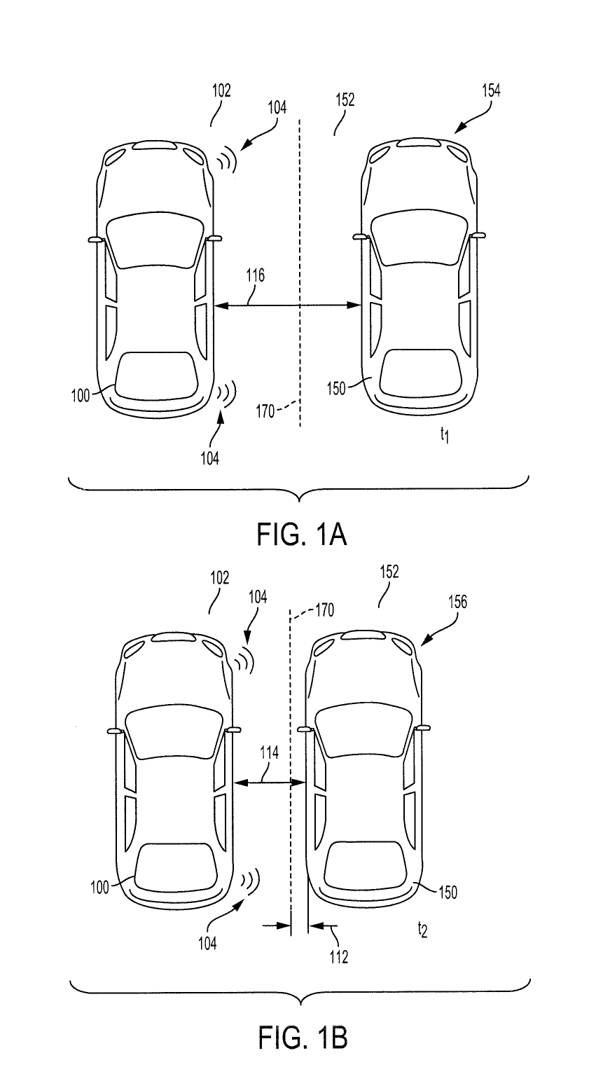

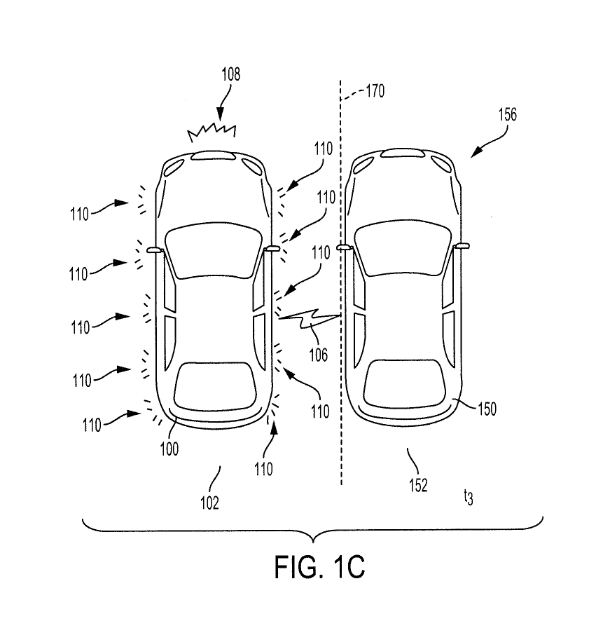

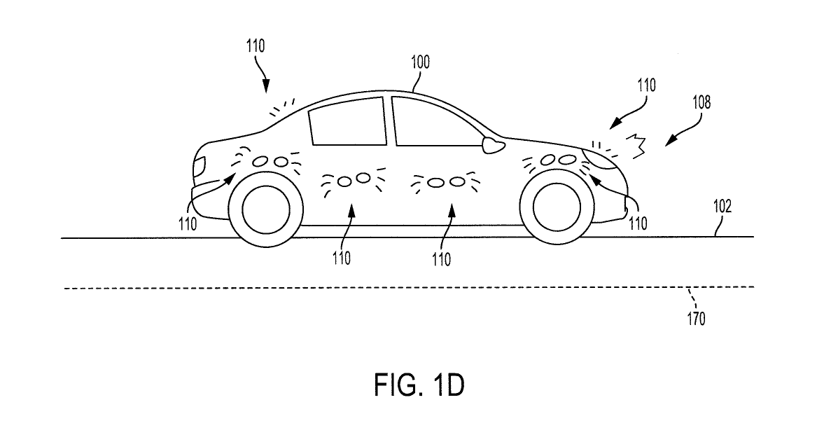

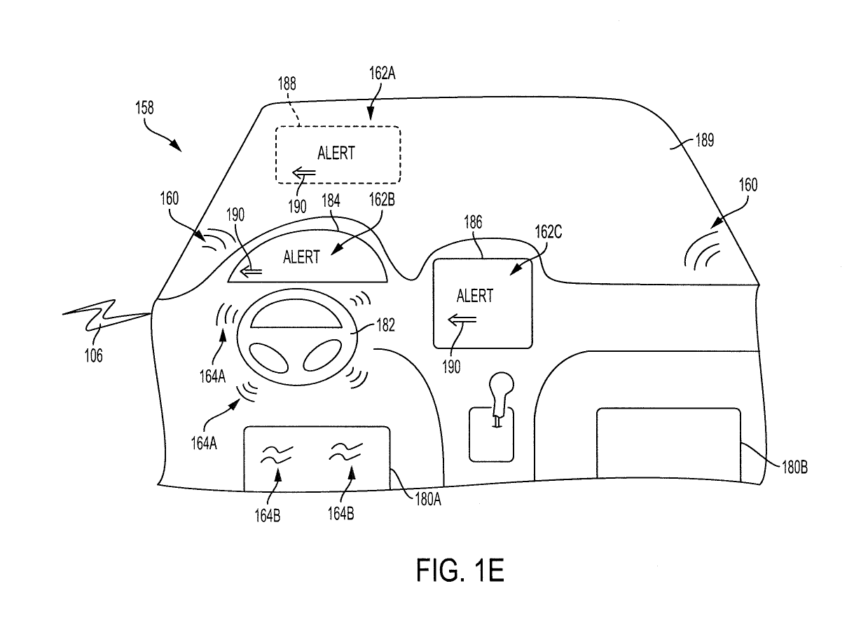

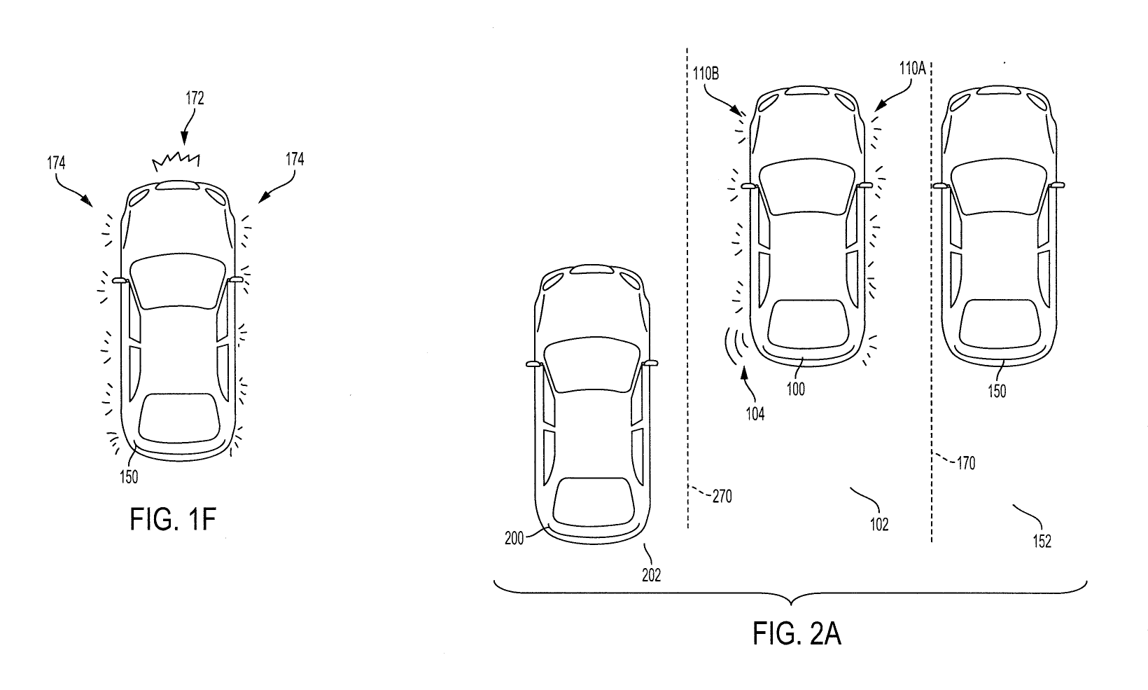

FIG. 1A illustrates a first vehicle 100. The first vehicle 100 may be an electric vehicle, an internal combustion engine vehicle, a hybrid vehicle, a fuel cell vehicle, or any combination thereof. The first vehicle 100 may be a vehicle operated by an individual, operated semi-autonomously or fully autonomously, operated remotely, or any combination thereof. As used herein, “driver,” “user,” or “operator” may refer to a human being driving the first vehicle 100 when the first vehicle 100 is a non-autonomous vehicle or operating in a non-autonomous mode. “Driver,” “user,” or “operator” may also refer to a computing system or control unit controlling the operation of the first vehicle 100 when the first vehicle 100 is a semi-autonomous or fully autonomous vehicle.

The first vehicle 100 is traveling in a first lane 102, alongside a second vehicle 150 in a second lane 152, at time t1. The first lane 102 and the second lane 152 are adjacent to each other, and are separated by a lane marker, such as lane line 170. The second vehicle 150 is in an initial position 154. In the initial position 154, the second vehicle 150 is a distance 116 away from the first vehicle 100 where there may not be a concern of a possible collision between the second vehicle 150 and the first vehicle 100.

FIG. 1B illustrates the first vehicle 100 traveling in the first lane 102, and the second vehicle 150 traveling in the second lane 152. The second vehicle 150 has moved closer to the first vehicle 100, as compared to FIG. 1A. The second vehicle 150 may now be in an encroaching position 156 and may be an encroaching vehicle, from the perspective of the first vehicle 100. As used herein, “second vehicle” and “encroaching vehicle” may be used interchangeably.

The second vehicle 150 may risk a collision with the first vehicle 100 if the second vehicle 150 continues to move toward the first vehicle 100. A driver of the second vehicle 150 may be distracted by a passenger, a display unit within the second vehicle 150, or a mobile device, such as a smartphone. The driver of the second vehicle 150 may be impaired by alcohol, drugs, or fatigue. The driver of the second vehicle 150 may not be distracted or impaired, and may simply be an unskilled driver.

The first vehicle 100 may detect the second vehicle 150 being in the encroaching position 156. Further, the first vehicle 100 may detect a possible collision based on the position of the second vehicle 150. The first vehicle 100 may include a proximity sensor 104 configured to detect proximity data.

The proximity data may be associated with a proximity of an object to the first vehicle. For example, the proximity data may indicate the proximity of a tree or another vehicle with the first vehicle 100. As shown in FIG. 1B, the proximity data may indicate the distance 114 between the second vehicle 150 and the first vehicle 100.

The proximity data may be associated with a proximity of an object to a reference point. For example, as shown in FIG. 1B, the proximity data may be associated with a distance 112 between the second vehicle 150 and the lane line 170. While FIG. 1B illustrates the second vehicle 150 as being entirely in the second lane 152, the second vehicle 150 may be partially in the first lane 102 and partially in the second lane 152, such that the second vehicle 150 is on both sides of the lane line 170. In the case where the second vehicle 150 is on both sides of the lane line 170, the distance between the second vehicle 150 and the lane line 170 may be expressed as a negative value to indicate that the second vehicle 150 has exceeded the boundary of the reference point, lane line 170.

The proximity data may be associated with a proximity rate of an object to the first vehicle 100, over time. For example, the proximity data may indicate the rate at which the second vehicle 150 approaches the first vehicle 100. As shown in FIGS. 1A and 1B, the proximity data may indicate the change in distance between the first vehicle 100 and the second vehicle 150 in the initial position 154 (i.e., distance 116) and the distance between the first vehicle 100 and the second vehicle 150 in the encroaching position 156 (i.e., distance 114), divided by the time difference (i.e., t2−t1). The proximity rate of the object to the first vehicle 100 indicates how quickly the object is moving toward the first vehicle 100, and may be a reliable indicator of a potential collision.

The first vehicle 100 may determine a possible collision based on the proximity data. When the proximity data is an indication of the distance 114 between the second vehicle 150 and the first vehicle 100, the first vehicle 100 may determine whether the distance 114 is less than a distance threshold. When the distance 114 is less than the distance threshold, the first vehicle 100 determines the possible collision. For example, if the proximity sensor 104 of the first vehicle 100 detects a distance 114 of 20 inches, and the distance threshold is 24 inches, the first vehicle 100 detects a possible collision.

When the proximity data is an indication of the distance 112 between the second vehicle 150 and the lane line 170, the first vehicle 100 may determine whether the distance 112 is less than a lane distance threshold. When the distance 112 is less than the lane distance threshold, the first vehicle 100 determines the possible collision. For example, if the proximity sensor 104 of the first vehicle 100 detects a distance 112 of 2 inches and the lane distance threshold is 2.5 inches, the first vehicle 100 detects a possible collision.

When the proximity data is an indication of a proximity rate change between the second vehicle 150 and the first vehicle 100, the first vehicle 100 may determine whether the proximity rate change exceeds a proximity rate change threshold. For example, if the proximity sensor 104 detects a distance 116 at t1 of 55 inches and the proximity sensor 104 detects a distance 114 of 20 inches at t2, 4 seconds after t1, the proximity rate change is 35 inches/4 seconds=8.75 inches per second. The proximity rate change threshold may be 5 inches per second. As the detected proximity rate change of 8.75 inches per second exceeds the proximity rate change threshold of 5 inches per second, the first vehicle 100 detects a possible collision.

In some situations, a proximity rate change degree may also be considered. For example, if the distance between the first vehicle 100 and the second vehicle 150 gradually decreases from distance 116 to distance 114, the first vehicle 100 may not detect a possible collision, as the driver of the second vehicle 150 may simply have drifted, but is paying attention and will return to a safe distance between the vehicles. However, if the distance between the first vehicle 100 and the second vehicle 150 swiftly decreases from distance 116 to distance 114, the first vehicle 100 may detect a possible collision, as the change in distance is more dramatic and may indicate a loss of attention or impairment, giving rise to a collision. In some embodiments, the distance between the first vehicle 100 and the second vehicle 150 may be plotted over time, and when the slope of a line between any two data points exceeds a threshold slope, a possible collision may be detected.

In another example situation, the second vehicle 150 may drift toward the first vehicle 100 at a first speed, for example, 3 feet per second, but may slow down to a second lesser speed, for example, 2 feet per second. The first vehicle 100 may detect this change in approaching speed as a negative acceleration toward the first vehicle 100 (or reduction in the proximity rate change between the first vehicle 100 and the second vehicle 150) and the first vehicle 100 may accordingly not detect a possible collision.

FIGS. 1C and 1D illustrate the first vehicle 100 communicating a warning indication to the second vehicle 150. The warning indication may be output by the first vehicle 100. The warning indication from the first vehicle 100 may include an audio indication. The first vehicle 100 may include a horn or speakers configured to produce a sound 108, such as a honk or other audible sound. The warning indication from the first vehicle 100 may include a visual indication. The first vehicle 100 may include one or more lights to produce a visual indication 110 to alert the driver of the second vehicle 150. The one or more lights may be along the sides of the first vehicle 100, may be along the front or rear of the first vehicle 100, or may be on the top of the first vehicle 100.

A warning indication may also be output by the second vehicle 150 inside the passenger cabin of the second vehicle 150. The warning indication may be triggered by a communication from the first vehicle 100. The first vehicle 100, upon detecting the possible collision, may generate warning data to communicate to the second vehicle 150. The warning data may be communicated via a wireless data connection 106, such as Bluetooth, or vehicle-to-vehicle communications protocol. Upon receiving the warning data, the second vehicle 150 may output the warning indication.

FIG. 1E illustrates warning indications output by the second vehicle 150 within the cabin 158 of the second vehicle 150. The warning indication from the second vehicle 150 may include a visual indication. The second vehicle 150 may include a gauge display 184, an entertainment unit display 186, and/or a heads-up display 188. The heads-up display 188, gauge display 184, and/or entertainment unit display 186 may display a visual alert 162A, 162B, and 162C, respectively. The visual alert 162 may include a direction 190 in which the second vehicle 150 may cause a potential collision. The gauge display 184 may be an LCD display that also includes a speedometer, odometer, and/or tachometer. The entertainment unit display 186 may be an LCD display that also includes vehicle trip information, navigation information, map information, time information, or music information, for example. The heads-up display 188 may be projected onto a front window 189 of the second vehicle 150.

The warning indication from the second vehicle 150 may include an audio indication. The second vehicle 150 may include a speaker configured to output sound 160. The sound 160 may be stronger in the direction in which the second vehicle 150 may cause a potential collision. For example, when the second vehicle 150 may cause a potential collision with the first vehicle 100 on the left (driver's) side of the second vehicle 150, the sound 160 on the left (driver's) side may be louder. The sound 160 may be, for example, a beep, honk, or spoken word, such as “danger” or “alert.”

The warning indication from the second vehicle 150 may include a tactile indication. The second vehicle 150 may include a vibration unit configured to output a vibration 164. The vibration unit may be connected to a steering wheel 182 to produce a steering wheel vibration 164A. The vibration unit may also be connected to a seat 180 to produce a seat vibration 164B. The seat vibration 164B may only occur in the driver's side seat 180A and not in the passenger's seat 180B. In some embodiments, all seats 180 vibrate to alert any occupants of the second vehicle 150.

Upon receiving the warning data from the first vehicle 100, the second vehicle 150 may automatically adjust operations and apply braking to slow down the second vehicle 150 or tighten steering to prevent the second vehicle 150 from further approaching the first vehicle 100.

FIG. 1F illustrates the second vehicle 150 outputting warning indications. The warning indications may be a visual indication 174 from one or more lights. The warning indications may also be an audio indication 172 from one or more speakers or horns. The warning indications from the second vehicle 150 may be used to alert others around the second vehicle 150, that the second vehicle 150 is being driven erratically or improperly and may pose a threat to others. The warning indications from the second vehicle 150 may be output temporarily until a condition is met. The condition may be based on time. For example, the second vehicle 150 may output the warning indications for 10 seconds. The condition may be based on distance. For example, the second vehicle 150 may output the warning indications for the next 3 miles of travel. The condition may be powering off of the second vehicle 150.

The second vehicle 150 may output the warning indications based on the warning data received from the first vehicle 100. The second vehicle 150 may output the warning indications based on the second vehicle 150 detecting one or more possible collisions. For example, the second vehicle 150 may include a proximity sensor similar to the proximity sensor of the first vehicle 100, configured to detect proximity data. The second vehicle 150, based on the proximity data, may determine the second vehicle 150 is too close to a lane marker, such as lane line 170, as shown in FIG. 1B. When the second vehicle 150 determines the distance 112 between the second vehicle 150 and the lane line 170 is less than a lane distance threshold, the second vehicle 150 may detect a potential collision. In response to detecting the potential collision, the second vehicle 150 may activate the warning indication (e.g., visual indication 174 and/or the audio indication 172).

The warning indication output by the second vehicle 150 may serve a similar purpose as a “student driver” sign for a vehicle with an individual learning how to drive operating the vehicle. Other vehicles may observe the warning indications and be advised to avoid being too close to the second vehicle 150.

As shown in FIGS. 1A-1E, the potential collision is detected by the first vehicle 100, and a warning indication is communicated to the second vehicle 150. When the second vehicle 150 is a non-autonomous vehicle, the driver of the second vehicle 150 is responsible for seeing, hearing, or feeling the warning indication and adjusting his/her driving to avoid the potential collision. When the second vehicle 150 is a semi-autonomous or fully autonomous vehicle, an electronic control unit configured to operate the second vehicle 150 is responsible for adjusting the operation of the second vehicle 150 to avoid the potential collision.

In some embodiments, the second vehicle 150 is incapable of detecting a potential collision on its own and relies on the first vehicle 100 to alert the second vehicle 150.

In some embodiments, the second vehicle 150 is capable of detecting a potential collision or is capable of detecting lane departure. In these embodiments, the second vehicle 150 may alert the driver when the second vehicle 150 is departing from the second lane 152 or when the second vehicle 150 may cause a potential collision. However, the driver of the second vehicle may not acknowledge the alert. In these situations, the additional warning indications from the first vehicle 100 (e.g., sound 108 or visual indication 110) or the additional warning indications from the second vehicle 150 triggered by the first vehicle 100 (e.g., sound 160, visual alert 162, or vibration 164) may supplement the technology of the second vehicle 150.

In some situations, the first vehicle 100 may automatically perform a collision avoidance maneuver, in case the second vehicle 150 continues to get closer to the first vehicle 100.

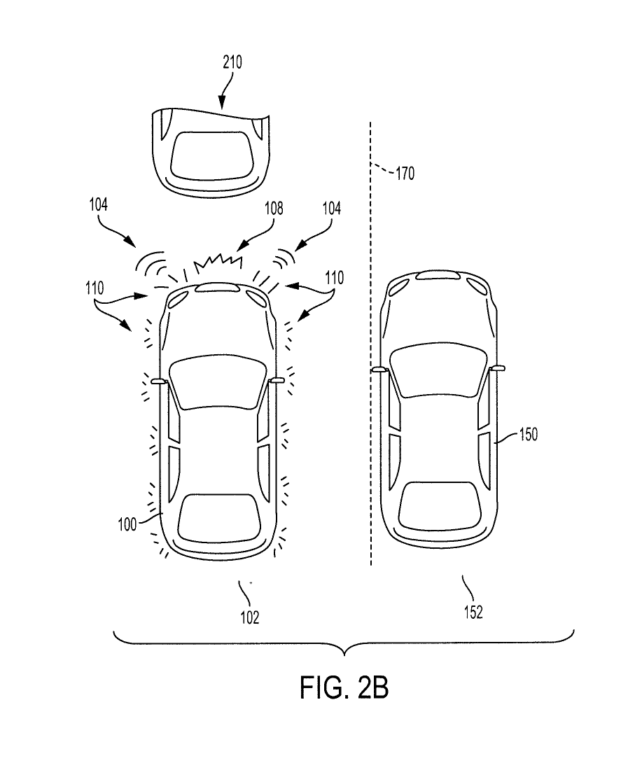

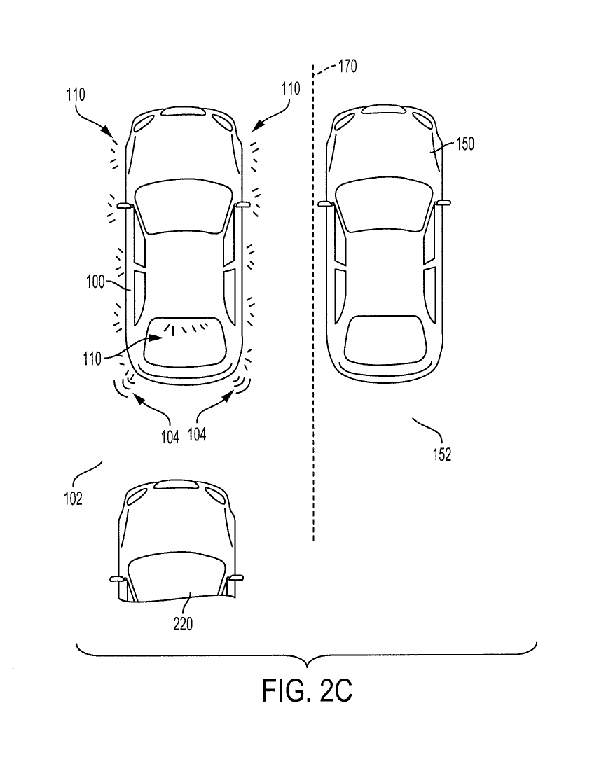

FIG. 2A illustrates the first vehicle 100 determining a collision avoidance maneuver to avoid the second vehicle 150 when a side vehicle 200 is traveling alongside the first vehicle 100. The first vehicle 100, having detected the possible collision, may be displaying a visual indication 110. The first vehicle 100 may display a right side visual indication 110A to alert the driver of the second vehicle 150. The first vehicle 100 may also display a left side visual indication 110B to alert the driver of the side vehicle 200 that there may be a potential collision or that the first vehicle 100 may move into the side vehicle's lane 202.

The first vehicle 100 may detect proximity data using proximity sensor 104. The proximity data may indicate proximity of any object around the first vehicle 100, such as the side vehicle 200. The first vehicle 100 may analyze the proximity data to determine a collision avoidance maneuver. The first vehicle 100 may determine that moving to the left is not possible because of the side vehicle 200. However, the first vehicle 100 may determine that no vehicles are in front of the first vehicle 100 or behind the first vehicle 100, and the collision avoidance maneuver may be to slow down or speed up. The first vehicle 100 may detect a lane marker, such as lane line 270 to assist in determining whether side vehicle 200 is another vehicle or a barrier, such as a wall or other structure.

As shown in FIG. 2B, when a front vehicle 210 is traveling in front of the first vehicle 100, the first vehicle 100 may determine that speeding up is not possible, as the front vehicle 210 is detected by the proximity sensor 104. Instead, the first vehicle 100 may determine that the collision avoidance maneuver may be to move a lane to the left, if there is a left lane, or to slow down.

The first vehicle 100 may display a front visual indication 110 to alert the driver of the front vehicle 210 that there may be a potential collision between the first vehicle 100 and the second vehicle 150. The first vehicle 100 may also output an audio indication, such as sound 108 to alert the driver of the front vehicle 210 that there may be a potential collision between the first vehicle 100 and the second vehicle 150.

As shown in FIG. 2C, when a rear vehicle 220 is traveling behind the first vehicle 100, the first vehicle 100 may determine that slowing down is not possible, as the rear vehicle 220 is detected by the proximity sensor 104. Instead, the first vehicle 100 may determine that the collision avoidance maneuver may be to speed up or to move lanes to the left, if there is a left lane.

The first vehicle 100 may display a rear visual indication 110 to alert the driver of the rear vehicle 220 that there may be a potential collision between the first vehicle 100 and the second vehicle 150.

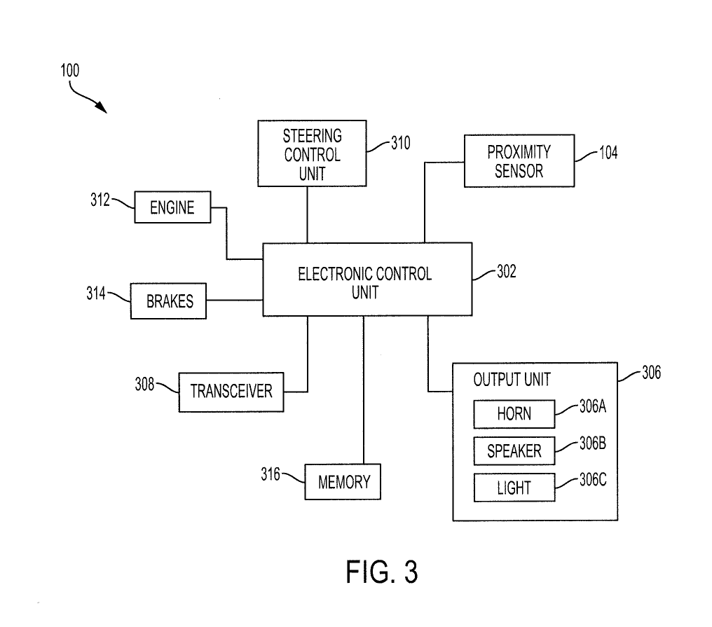

FIG. 3 illustrates a block diagram of the first vehicle 100. The first vehicle 100 includes, for example, an electronic control unit (ECU) 302. The ECU 302 is configured to control functions of the first vehicle 100. The ECU 302 is connected to a proximity sensor 104. The ECU 302 is also connected to an output unit 306, a first vehicle transceiver 308, a steering control unit 310, an engine 312, and brakes 314. The various elements of the first vehicle 100 may communicate with each other directly or via a communications bus, such as a CAN bus.

The proximity sensor 304 may be configured to detect proximity data associated with a proximity of the second vehicle 150 to the first vehicle 100. The proximity sensor 304 may be a radar, LIDAR, SONAR, or other sensor configured to detect spatial data. As disclosed herein, the proximity of the second vehicle 150 to the first vehicle 100 may be determined by the direct proximity of the second vehicle 150 to the first vehicle 100, the rate of change of proximity of the second vehicle 150 approaching the first vehicle 100, or the distance between the second vehicle 150 and a lane marker, such as lane line 170. Based on the proximity data, the ECU 302 is configured to determine the proximity of the second vehicle 150 to the first vehicle 100.

The output unit 306 includes, for example, a horn 306A, a speaker 306B, and/or a light 306C. The horn 306A may be configured to output a brief and simple audio warning indication that is a honk or beep, for example. The speaker 306B may be configured to output a complex and longer audio warning indication that is a spoken message, or an alarm, for example.

The horn 306A may include one or more horns. When the horn 306A includes a plurality of horns, each horn may be oriented in a different direction. For example, a front horn may be oriented to output the audio warning indication in front of the first vehicle 100, a left horn may be oriented to output the audio warning indication to the left side of the first vehicle 100, a right horn may be oriented to output the audio warning indication to the right of the first vehicle 100, and a rear horn may be oriented to output the audio warning indication to the rear of the first vehicle 100.

When the horn 306A includes a plurality of horns, one directional horn may output an audio warning indication, and the other horns may output a cancelling audio warning indication such that the cancelling audio warning indication partially or completely cancels the audio warning indication output by the one directional horn. For example, when the first vehicle 100 includes a left horn, a right horn, a front horn, and a rear horn, and the second vehicle 150 is on the first vehicle's 100 right side, the right horn may output a beep to warn the second vehicle 150. The front horn, the left horn, and the rear horn may output a cancelling beep that is the inverse of the beep output from the right horn. The cancelling beep may partially or completely cancel the beep from the right horn, from the perspective of a vehicle in front of the first vehicle 100, to the left of first vehicle 100, or behind first vehicle 100. In this way, the beep output by the right horn may not cause a distraction to other drivers.

Similarly, the speaker 306B may include one or more speakers. When the speaker 306B includes a plurality of speakers, each speaker may be oriented in a different direction. When the speakers 306B includes a plurality of speakers, each speaker may output a different audio warning indication. For example, when the first vehicle 100 includes a left speaker and a right speaker, and the second vehicle 150 is on the first vehicle's 100 right side, the right speaker may output a message of “watch out on your left side” to warn the second vehicle 150, and the left speaker may output a message of “watch out on your right side” to warn a side vehicle that there may be a collision in the adjacent lanes. When the speaker 306B includes a plurality of speakers, one directional speaker may output an audio warning indication, and the other speakers may output a cancelling audio warning indication such that the cancelling audio warning indication partially or completely cancels the audio warning indication output by the one directional speaker.

The light 306C may be mounted on the side of the first vehicle 100, as shown in FIG. 1D. The light 306C may include front headlights and rear tail lights of first vehicle 100. The light 306C may be an LED light or an incandescent light. The light 306C may be a display screen configured to display a message, such as “WATCH OUT” or “WARNING” to the second vehicle 150.

The first vehicle transceiver 308 is configured to transmit warning data to the second vehicle 150. The first vehicle transceiver 308 may be configured to transmit the warning data using a wireless communications protocol, such as Bluetooth or a vehicle to vehicle communications protocol. The second vehicle 150 receives the warning data using a corresponding second vehicle transceiver and the second vehicle 150 may output a warning indication accordingly, as described herein. The first vehicle transceiver 308 may be configured to receive data from one or more sources, including the second vehicle 150. The second vehicle 150 may communicate, to the first vehicle 100 via their respective transceivers, an indication that the second vehicle 150 is unwilling or unable to maintain a distance from the first vehicle 100. In these situations, the first vehicle 100 may determine a collision avoidance maneuver to perform, to attempt to avoid a collision.

In some embodiments, the warning data transmitted by the first vehicle transceiver 308 is the audio warning indication and/or the visual warning indication, and the second vehicle 150 receives the audio warning indication and/or the visual warning indication by detecting audio signals and/or visual signals and analyzing them.

When the first vehicle 100 is a semi-autonomous or fully autonomous vehicle, the first vehicle 100 may be controlled by the ECU 302. The ECU 302 may determine steering of the first vehicle 100, acceleration of the first vehicle 100, and braking of the first vehicle 100. The ECU 302 may use the steering control unit 310 to steer the first vehicle 100. The ECU 302 may adjust acceleration of the first vehicle 100 using engine 312. The engine 312 may be an internal combustion engine, a motor, or a combination of both. The ECU 302 may adjust braking of the first vehicle 100 using the brakes 314.

In an example embodiment, and as shown in FIGS. 2A-2C, when the ECU 302 determines a collision avoidance maneuver, the ECU 302 may control the first vehicle 100 via the steering control unit 310, the engine 312, and the brakes 314. As shown in FIG. 2A, when the ECU 302 determines that an adjacent lane (e.g., lane 202) is occupied by a side vehicle 200, the ECU 302 may determine a collision avoidance maneuver of slowing the first vehicle 100 down by applying the brakes 314. As shown in FIG. 2B, when the ECU 302 determines accelerating is not an option, the ECU 302 may determine a collision avoidance maneuver of moving to an unoccupied adjacent lane. The ECU 302 may communicate an instruction to the steering control unit 310 to steer the first vehicle 100 into the unoccupied adjacent lane. As shown in FIG. 2C, when the ECU 302 determines slowing down is not an option, the ECU 302 may determine a collision avoidance maneuver of accelerating. The ECU 302 may communicate an instruction to the engine 312 to accelerate.

The ECU 302 is connected to the memory 316. The memory 316 is configured to store threshold values, such as distance threshold, lane distance threshold, proximity rate change threshold, and threshold slope, as described herein.

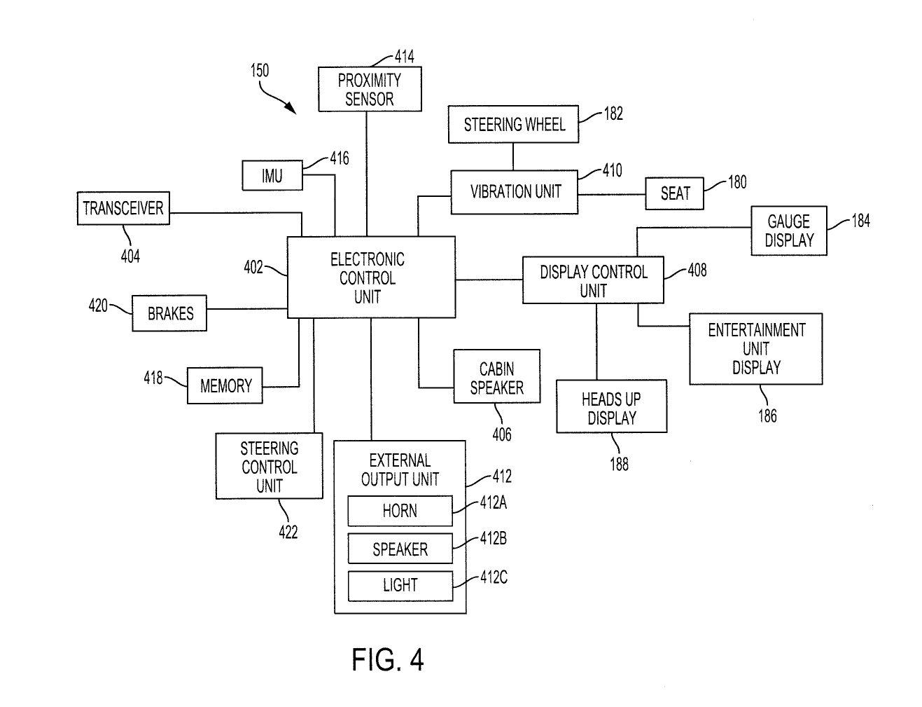

FIG. 4 illustrates a block diagram of the second vehicle 150. The second vehicle 150 includes an electronic control unit (ECU) 402, a transceiver 404, a cabin speaker 406, a display control unit 408, a vibration unit 410, an external output unit 412, a proximity sensor 414, an inertial measurement unit 416, a memory 418, brakes 420, and a steering control unit 422, for example. The ECU 402 is configured to the control the functions of the second vehicle 150.

The ECU 402 is connected to the transceiver 404. The transceiver 404 of the second vehicle 150 is configured to receive warning data from the transceiver 308 of the first vehicle 100. The transceiver 404 of the second vehicle 150 may communicate data to the transceiver 308 of the first vehicle 100, as described herein.

The ECU 402 is also connected to the cabin speaker 406. The cabin speaker 406 may output an audio indication, such as sound 160 shown in FIG. 1E. The ECU 402 may instruct the cabin speaker 406 to output sound 160 based on the warning data indicating a possible collision between the first vehicle 100 and the second vehicle 150.

The ECU 402 is also connected to the display control unit 408. The display control unit 408 may be configured to control aspects of one or more displays within the cabin 158 of second vehicle 150, as shown in FIG. 1E. The one or more display may include a gauge display 184, an entertainment unit display 186, and a heads-up display 188. The ECU 402 may instruct the display control unit 408 to output a visual indication based on the warning data indicating a possible collision between the first vehicle 100 and the second vehicle 150.

The ECU 402 is also connected to the vibration unit 410. The vibration unit 410 is connected to the seat 180 and the steering wheel 182. As shown in FIG. 1E, the vibration unit 410 may be used to output a tactile indication by causing the seat 180 and/or the steering wheel 182 to vibrate when the warning data indicates a possible collision between the first vehicle 100 and the second vehicle 150.

The ECU 402 is also connected to the external output unit 412. The external output unit 412 includes a horn 412A, a speaker 412B, and a light 412C, similar to the horn 306A, the speaker 306B, and the light 306C of the first vehicle 100. The external output unit 412 may be used when the ECU 402 determines that the second vehicle 150 is being driven erratically or improperly and may pose a threat to others, as shown in FIG. 1F.

The ECU 402 may determine that the second vehicle 150 is being driven erratically or improperly based on the warning data and/or the sensor data detected using the proximity sensor 414. The ECU 402 may determine that the second vehicle 150 is being driven erratically or improperly when the second vehicle 150 is in a possible collision with another vehicle more than a threshold number of times (an “erratic or improper driving count threshold”). For example, the second vehicle 150 may receive, from the first vehicle 100 and/or other vehicles similar to first vehicle 100, warning data. The second vehicle 150 may have received warning data 50 times, and the erratic or improper driving count threshold may be receiving warning data 20 times. The ECU 402 determines the second vehicle 150 is being driven erratically or improperly and outputs one or more warning indications using the external output unit 412.

The ECU 402 may determine the second vehicle 150 is being driven erratically or improperly when the second vehicle 150 is in a possible collision with another vehicle more than a threshold number of times in a period of time (an “erratic or improper driving frequency threshold”). For example, the second vehicle 150 may receive, from the first vehicle 100 and/or other vehicles similar to first vehicle 100, warning data. The second vehicle 150 may have received warning data 15 times in the last hour, and the erratic or improper driving frequency threshold may be receiving warning data 2 times in a one hour span. The ECU 402 determines the second vehicle 150 is being driven erratically or improperly and outputs one or more warning indications using the external output unit 412. Further, the ECU 402 may monitor a number of times the erratic or improper driving frequency threshold or erratic or improper driving count threshold has been exceeded, and the ECU 402 may then determine the second vehicle 150 is being driven erratically or improperly. For example, if the erratic or improper driving frequency threshold or the erratic or improper driving count threshold has been exceeded more than 3 times, the ECU 402 may determine the second vehicle 150 is being driven erratically or improperly.

The ECU 402 may determine the second vehicle 150 is being driven erratically or improperly when the second vehicle 150 performs a number of erratic or improper maneuvers exceeding the erratic or improper driving count threshold or when the second vehicle 150 performs a number of erratic or improper maneuvers in a period of time, exceeding the erratic or improper driving frequency threshold. An erratic or improper maneuver may be detected by the proximity sensor 414.

Erratic or improper maneuvers may include driving at a speed above a speed threshold relative to other surrounding vehicles. For example, the second vehicle 150 may be traveling at a speed of 120 miles per hour, and other vehicles in the vicinity of the second vehicle 150 may be traveling at a speed of 80 miles per hour. The speed threshold may be 30 miles per hour. The difference between the second vehicle 150 speed and the speed of the other vehicles exceeds the speed threshold. The speed of the other vehicles in the vicinity of the second vehicle 150 may be determined by the proximity sensor 414 detecting a relative speed of the other vehicles, or by a third party vehicle speed data aggregating system, which may collect vehicle speed data from numerous vehicles in the area of the second vehicle 150 via transceivers of the respective numerous vehicles. When the difference between the second vehicle 150 speed and the speed of the other vehicles exceeds the speed threshold, the ECU 402 determines the second vehicle 150 is being driven erratically or improperly and outputs one or more warning indications using the external output unit 412. In some embodiments, the ECU 402 determines the second vehicle 150 is being driven erratically or improperly when the difference between the second vehicle 150 speed and the speed of the other vehicles exceeds the speed threshold for a sustained period of time.

Erratic or improper maneuvers may include driving at a speed below a speed threshold relative to other surrounding vehicles. For example, the second vehicle 150 may be traveling at a speed of 20 miles per hour, and other vehicles in the vicinity of the second vehicle 150 may be traveling at a speed of 80 miles per hour. The speed threshold may be 30 miles per hour. The difference between the speed of the other vehicles and the second vehicle 150 speed exceeds the speed threshold. Accordingly, the ECU 402 determines the second vehicle 150 is being driven erratically or improperly and outputs one or more warning indications using the external output unit 412. In some embodiments, the ECU 402 determines the second vehicle 150 is being driven erratically or improperly when the difference between the speed of the other vehicles and the second vehicle 150 speed exceeds the speed threshold for a threshold period of time (an “erratic or improper driving time threshold”). In some situations, when the second vehicle 150 is being driven at a low speed relative to the other vehicles in the area, the second vehicle 150 may be encountering a malfunction, and the warning indications output by the external output unit 412 may serve as a distress signal.

Erratic or improper maneuvers may include being within a threshold distance of a lane marker, such as lane line 170. For example, a lane distance threshold may be 2 inches and the proximity sensor 414 detects the second vehicle has come within 2 inches of the lane marker 15 times in the past 30 minutes. The erratic or improper driving frequency threshold may be coming within the lane distance threshold 5 times in a 30 minute span. The ECU 402 determines the second vehicle 150 is being driven erratically or improperly and outputs one or more warning indications using the external output unit 412.

Erratic or improper maneuvers may include lateral movement exceeding a lateral movement threshold, indicating swerving of the second vehicle 150. Lateral movement may be detected by the proximity sensor 414, which may detect abrupt changes in distances between the second vehicle 150 and objects to the left and right of the second vehicle 150. An inertial measurement unit (IMU) 416 may also be used to detect abrupt lateral movement. For example, lateral movement may be measured in G forces, and the second vehicle 150 may move from right to left at a force of 0.3 Gs. The lateral movement threshold may be 0.2 Gs. The ECU 402 determines the second vehicle 150 is being driven erratically and outputs one or more warning indications using the external output unit 412.

The proximity sensor 414 may be configured to detect proximity data associated with proximity of the second vehicle 150 to objects in the vicinity of the second vehicle 150. The proximity sensor 414 may be a radar, LIDAR, SONAR, or other sensor configured to detect spatial data.

The memory 418 is configured to store threshold values associated with the second vehicle 150, such as the erratic or improper driving count threshold, erratic or improper driving frequency threshold, speed threshold, lateral movement threshold, lane distance threshold, and erratic or improper driving time threshold, as described herein.

Upon receiving the warning data from the first vehicle 100 via the second vehicle transceiver 404, the second vehicle 150 may adjust operations of the second vehicle 150. The ECU 402 may communicate an indication to the brakes 420 to apply the brakes 420 and slow down the second vehicle 150. The ECU 402 may communicate an indication to the steering control unit 422 to tighten the steering such that the second vehicle 150 may not further approach the first vehicle 100. The ECU 402 may communicate an indication to the steering control unit 422 to steer the second vehicle 150 away from the first vehicle 100 to avoid the potential collision.

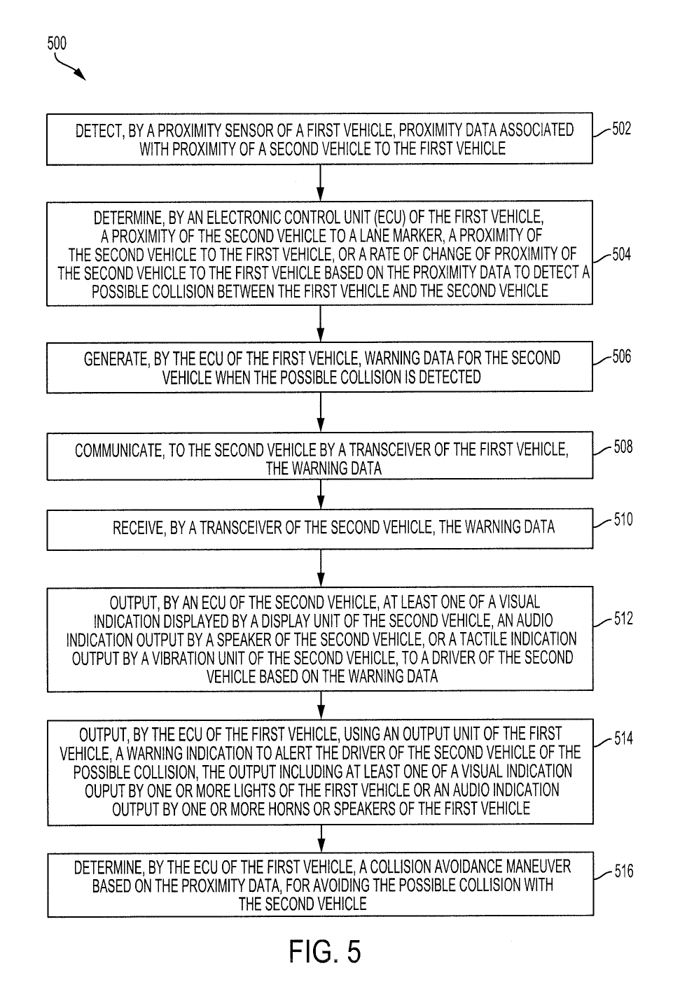

FIG. 5 illustrates an example of a flowchart describing the collision alert system. The process 500 may be used by the first vehicle 100 and/or the second vehicle 150, as described herein.

A proximity sensor 104 of a first vehicle 100 detects proximity data associated with a proximity of the second vehicle 150 to the first vehicle 100 (step 502). As described herein, the proximity data may indicate the distance between the first vehicle 100 and an object in the vicinity of the first vehicle 100, such as the second vehicle 150 or a lane marker.

An electronic control unit (ECU) 302 of the first vehicle 100 determines a proximity of the second vehicle 150 to a lane marker, a proximity of the second vehicle 150 to the first vehicle 100, or a rate of change of proximity of the second vehicle 150 to the first vehicle 100 based on the proximity data to detect a possible collision between the first vehicle 100 and the second vehicle 150 (step 504). As described herein, the ECU 302 of the first vehicle 100 may detect the possible collision when the distance between the second vehicle 150 and the first vehicle 100 is less than a distance threshold. Also as described herein, the ECU 302 of the first vehicle 100 may detect the possible collision when the rate of change of proximity of the second vehicle 150 to the first vehicle 100 exceeds a proximity rate change threshold. Also as described herein, the ECU 302 of the first vehicle 100 may detect the possible collision when the distance between the second vehicle 150 and a lane marker is less than a lane distance threshold. The distance threshold, proximity rate change threshold, and lane distance threshold may be stored in the memory 316.

The ECU 302 of the first vehicle 100 generates warning data for the second vehicle 150 when the possible collision is detected (step 506). The first vehicle transceiver 308 communicates to the second vehicle 150, the warning data (step 508). The second vehicle transceiver 404 receives the warning data (step 510). In some embodiments, the first vehicle transceiver 308 and the second vehicle transceiver 404 communicate using a wireless communications protocol and the warning data is used by the second vehicle 150 to warn the driver of the second vehicle 150. In some embodiments, the warning data is an audio or visual indication that the first vehicle transceiver 308 communicates to the second vehicle transceiver 404, which detects the audio or visual indication and warns the driver of the second vehicle 150.

The ECU 402 of the second vehicle 150 outputs at least one of a visual indication displayed by a display unit of the second vehicle 150, an audio indication output by a cabin speaker 406 of the second vehicle 150, or a tactile indication output by a vibration unit 410 of the second vehicle 150, to a driver of the second vehicle 150 based on the warning data (step 512). As described herein, the display unit may include a gauge display 184, an entertainment unit display 186, or a heads-up display 188 and the display unit may be controlled by a display control unit 408. The vibration unit 410 may be connected to a seat 180 or a steering wheel 182. The visual indication, audio indication, and/or tactile indication are warning indications for alerting the driver of the second vehicle 150 that the driver of the second vehicle 150 may possibly cause a collision.

The ECU 302 of the first vehicle 100 outputs, using an output unit 306 of the first vehicle 100, a first vehicle warning indication to alert the driver of the second vehicle 150 of the possible collision. The output includes at least one of a visual indication output by one or more lights 306C of the first vehicle 100 or an audio indication output by one or more horns 306A or speakers 306B of the first vehicle 100 (step 514).

The ECU 302 of the first vehicle 100 determines a collision avoidance maneuver based on the proximity data, for avoiding the possible collision with the second vehicle 150 (step 516). As described herein, the first vehicle 100 may slow down, change lanes, or accelerate to avoid the possible collision, as long as doing so does not cause a different possible collision with another vehicle or object.

The steps of process 500 may be performed in any order, and may be performed contemporaneously with other steps. In particular, step 512, step 514, and step 516 may be performed in any order or may be performed contemporaneously.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that the scope shall not be restricted, except in light of the appended claims and their equivalents.

1. A vehicle encroachment warning system, comprising:
a proximity sensor of a first vehicle, the proximity sensor configured to detect proximity data associated with proximity of a second vehicle to the first vehicle;
an electronic control unit (ECU) of the first vehicle configured to:
determine a proximity of the second vehicle to a lane marker, a proximity of the second vehicle to the first vehicle, or a rate of change of proximity of the second vehicle to the first vehicle based on the proximity data to detect a possible collision between the first vehicle and the second vehicle, and
generate warning data for the second vehicle when the possible collision is detected;
a first vehicle transceiver configured to communicate the warning data to only the second vehicle;
a second vehicle transceiver configured to receive the warning data; and
an ECU of the second vehicle configured to output a warning indication to a driver of the second vehicle based on the warning data.

2. The vehicle encroachment warning system of claim 1, wherein the warning indication is a visual indication, and the warning indication is output by a display unit of the second vehicle.

3. The vehicle encroachment warning system of claim 1, wherein the warning indication is an audio indication, and the warning indication is output by a speaker of the second vehicle.

4. The vehicle encroachment warning system of claim 1, wherein the warning indication is a tactile indication, and the warning indication is output by a vibration unit of the second vehicle.

5. The vehicle encroachment warning system of claim 1, further comprising an output unit of the first vehicle, the output unit configured to output an external warning indication from the first vehicle directed to the second vehicle, to alert the driver of the second vehicle of the possible collision.

6. The vehicle encroachment warning system of claim 5, wherein the external warning indication is a visual indication from the first vehicle directed to the second vehicle, and the external warning indication is output by one or more lights on an exterior surface of the first vehicle.

7. The vehicle encroachment warning system of claim 5, wherein the external warning indication is an audio indication from the first vehicle directed to the second vehicle, and the external warning indication is output by one or more horns or speakers of the first vehicle.

8. A vehicle comprising:
a proximity sensor configured to detect proximity data associated with an encroaching vehicle;
an electronic control unit (ECU) configured to:
determine at least one of a distance of the encroaching vehicle to a lane marker, a distance of the encroaching vehicle to the vehicle, or a rate of change of proximity of the encroaching vehicle to the vehicle based on the proximity data to detect a possible collision with the encroaching vehicle, and
generate a warning indication when the possible collision is detected; and
an output unit configured to output the warning indication directed to only the encroaching vehicle to alert a driver of the encroaching vehicle of the possible collision, the output unit being a transceiver configured to communicate warning data to the encroaching vehicle, one or more lights on an exterior of the vehicle configured to display the warning indication visually, or one or more horns or speakers configured to communicate the warning indication audibly.

9.-10. (canceled)

11. The vehicle of claim 8, wherein the ECU detects the possible collision when the distance between the encroaching vehicle and the lane marker is less than a lane distance threshold.

12. The vehicle of claim 8, wherein the ECU detects the possible collision when the rate of change of proximity between the encroaching vehicle and the vehicle exceeds a proximity rate change threshold.

13. The vehicle of claim 8, wherein the ECU detects the possible collision when the distance between the encroaching vehicle and the vehicle is less than a distance threshold.

14. The vehicle of claim 8,
wherein the ECU is further configured to generate the warning data when the possible collision is detected, and
wherein the encroaching vehicle alerts a driver of the encroaching vehicle of the possible collision based on the warning data.

15. The vehicle of claim 8, wherein the proximity data is further associated with any object in proximity to the vehicle, and
wherein the ECU is further configured to determine, based on the proximity data, a collision avoidance maneuver, such that the possible collision with the encroaching vehicle is avoided.

16. A vehicle encroachment warning method comprising:
detecting, by a proximity sensor of a first vehicle, proximity data associated with proximity of a second vehicle to the first vehicle;
determining, by an electronic control unit (ECU) of the first vehicle, a proximity of the second vehicle to a lane marker, a proximity of the second vehicle to the first vehicle, or a rate of change of proximity of the second vehicle to the first vehicle based on the proximity data to detect a possible collision between the first vehicle and the second vehicle;
generating, by the ECU of the first vehicle, warning data for the second vehicle when the possible collision is detected;
communicating, to only the second vehicle by a first vehicle transceiver, the warning data;
receiving, by a second vehicle transceiver, the warning data; and
outputting, by an ECU of the second vehicle at least one of a visual indication displayed by a display unit of the second vehicle, an audio indication output by a speaker of the second vehicle, or a tactile indication output by a vibration unit of the second vehicle, to a driver of the second vehicle based on the warning data.

17. The method of claim 16, further comprising outputting, by an output unit of the first vehicle, an external warning indication directed to the second vehicle when the possible collision is detected, to alert the driver of the second vehicle of the possible collision.

18. The method of claim 17, wherein the external warning indication is at least one of a visual indication from the first vehicle directed to the second vehicle output by one or more lights located on an exterior surface of the first vehicle or an audio indication from the first vehicle directed to the second vehicle output by one or more speakers or horns of the first vehicle.

19. The method of claim 16, wherein the proximity data is further associated with any object in proximity to the first vehicle, and
wherein the method further comprises determining, by the ECU of the first vehicle, a collision avoidance maneuver based on the proximity data, for avoiding the possible collision with the second vehicle.

20. The method of claim 16, further comprising adjusting operation of the second vehicle, by the ECU of the second vehicle, when the warning data is received, for avoiding the possible collision with the second vehicle, the adjusting operation of the second vehicle including at least one of tightening steering of the second vehicle or slowing down the second vehicle.
